(19) United States
(12) Patent Application Publication
(10) Pub. No.: US 2026/0308929 A1
(43) Pub. Date: Oct. 8, 2026

(54) A PORTABLE CABIN AND METHOD OF TRANSPORTING PORTABLE CABINS

(71) Applicant: Solivus Limited, London (GB)

(72) Inventors: Joanna PARKER-SWIFT, Kent (GB); Ciaran COTTER, London (GB)

(21) Appl. No.: 19/484,915

(22) PCT Filed: May 17, 2024
(86) PCT No.: PCT/GB2024/051295

§ 371 Date: Nov. 17, 2025

(30) Foreign Application Priority Data
May 18, 2023 (GB) 2307408.1

(51) Int. Cl. E04H 1/12; H02S 20/30

(52) U.S. Cl. CPC E04H 1/1205; H02S 20/30

(57) ABSTRACT

A method of transporting portable cabins (1) having a flat roof (2) with a flat layer of lightweight or flexible solar material (10). The method comprises releasably attaching a protective layer (16) to cover the solar material (10) and transporting the cabin (1) with the covered solar material (10) in place. A portable cabin (1) with a flat layer of lightweight or flexible solar material (10) attached to the roof (2) is also disclosed.

Portable cabins are known in the building industry and the like to provide portable enclosures for onsite work spaces. The portable cabins generally have a rectangular cuboid shape and are designed to be stackable to allow multi layer structures to be formed.

In the absence of mains power, a diesel generator is conventionally supplied in order to provide a power source for the portable cabin. However, to provide a low carbon power source, a different solution is required.

One attempt to do this is to provide a hybrid solar/battery/generator system, that is designed to minimise generator run time. This design utilises conventional C—Si solar panels on the roof of the cabin forming a solar array. However, these solar panels are relatively heavy. They also need a mounting/ballast system further increasing the total mass. Due to the load limitation of the roof structure, this limits the size of solar array which can be used. In addition, the cabin structure requires reinforcement further adding to the cost and complication of implementation.

The panels then have to be removed for transportation. The removal process is time consuming, and the solar panels are awkward to transport as they are fragile components which require careful handling. In view of these difficulties, this has not proved to be a practical solution to the problem.

GB 2586172 discloses a cabin with removable panels on the roof. A similar arrangement is shown in GB 2584040. WO 2016/046531 discloses a shelter with a solar roof which is designed to be transported when disassembled into panels.

CN 111305602, CN 206693677 and CN 218858281 show examples of solar panels with relatively complex retractable, hinged and/or sliding mechanisms.

It is also known in the art to provide protective covers on solar panels for domestic use to cover the panels to protect them from extreme climate conditions such as frequent snowstorms and extended heat waves. These are summarised in an article by SolarSena entitled “Do Solar Panel Protective Covers Work? https://web.archive.org/web/20230203092653/https://solarsena.com/solar-panel-protective-covers-and-what-you-need-to-know/

According to a first aspect of the present invention, there is provided a method according to claim 1.

This provides a convenient way of providing solar power to the portable cabin which is simple to transport without having to remove and separately transport the solar panels.

Thus, the dismantling of the solar panels of the prior art for separate transportation and their subsequent reassembly is entirely eliminated. Instead, there is only a step of covering the solar material with a protective layer which can then be removed once the portable cabin has reached the destination.

The use of a layer of lightweight or flexible solar material which is attached flat to the flat roof means that the solar material can be used on a conventional cabin as no reinforcement of the cabin structure is required. This has a significant cost impact on the implementation of the invention.

The lightweight or flexible solar material is significantly lighter than conventional solar material allowing more of the surface area of the cabin roof to be covered with the solar material.

The solar material may be a thin film flexible solar material such as CIGS or OPV. However, preferably, the solar material is a lightweight rigid solar material. This has no glass layer. This means that it is lighter and is less susceptible to damage. It is also frameless which provides a lower profile material which is lighter in weight. The lightweight solar material is preferably a crystalline silicon (C—Si), with similar efficiencies to conventional C—Si solar modules.

The mass of the lightweight or flexible solar material is preferably less than 10 kg, and more preferably less than 8 kg per square metre. The solar material is mounted flat to the roof (i.e. parallel to the roof) preferably using a simple mounting such as an adhesive. Ideally this has a negligible weight such that the total added mass of the solar material and its mounting (including one or more of adhesive, subframe, cables and cable trays which are present) is preferably less than 10 kg, and more preferably less than 8 kg per square metre (measured as the area of the solar material, not the total roof).

The protective layer may be attached to the cabin taking advantage of existing features of the cabin to make the attachment. However, preferably the cabin comprises a mechanical fastening mechanism attached to the roof at least partially surrounding the solar material, and the method comprises attaching the protective layer to the mechanical fastening mechanism. This makes it easy to attach and detach the protective layer.

This provides a second aspect of the invention which is a portable cabin according to claim 14.

The cabin may further comprise stacking elements on the flat roof and/or the flat floor, the stacking elements being configured such that, when two cabins are stacked on one another, they provide a space between the cabins to accommodate the solar material.

The stacking elements then ensure that an upper cabin does not come into contact with the solar material on a lower cabin when the cabins are stacked.

The cabin may further comprise stacking elements on the flat roof and/or on the flat floor; the stacking elements being complementary such that, when two cabins are stacked on one another, the stacking elements form a space for the solar material.

Within a group of portable cabins, it is possible to provide solar material on all of the cabins. This provides maximum flexibility for their future deployment. However, some portable cabins may be provided without solar material and these can then be used below a cabin which does have solar material. This provides a cost reduction but reduced flexibility.

The requirement for the solar material to be attached flat to the flat roof requires that the solar material is generally parallel to the flat roof. In practice, there may be a gap under the solar material to stop water gathering on top of the solar material. Additionally or alternatively, the solar material may be mounted at a slight incline to allow water to drain off.

In practice, therefore the top of the solar material is preferably no more than 10 cm, and preferably no more than 5 cm above the part of the flat roof to which the solar material is attached.

Additionally or alternatively, the solar material is preferably inclined at an angle of less than 15 degrees, preferably less than 10 degrees and more preferably less than 5 degrees with respect to the roof.

Any such gap/incline is significantly less than conventional panels which are mounted at a 30 degree angle for maximum generating efficiency. In the present case, the gap and incline are made as small as possible while still preventing a build up of water on the solar material.

In order to achieve this a plurality of batons may be attached to the roof, wherein the layer of lightweight or flexible solar material is adhered to the batons. These can provide the gap and optional incline. Further, they allow the solar material to be easily removed by cutting through the adhesive interfaces between the solar material and the batons.

Examples of a portable cabin in accordance with the present invention will now be described with reference to the accompanying drawings, in which:

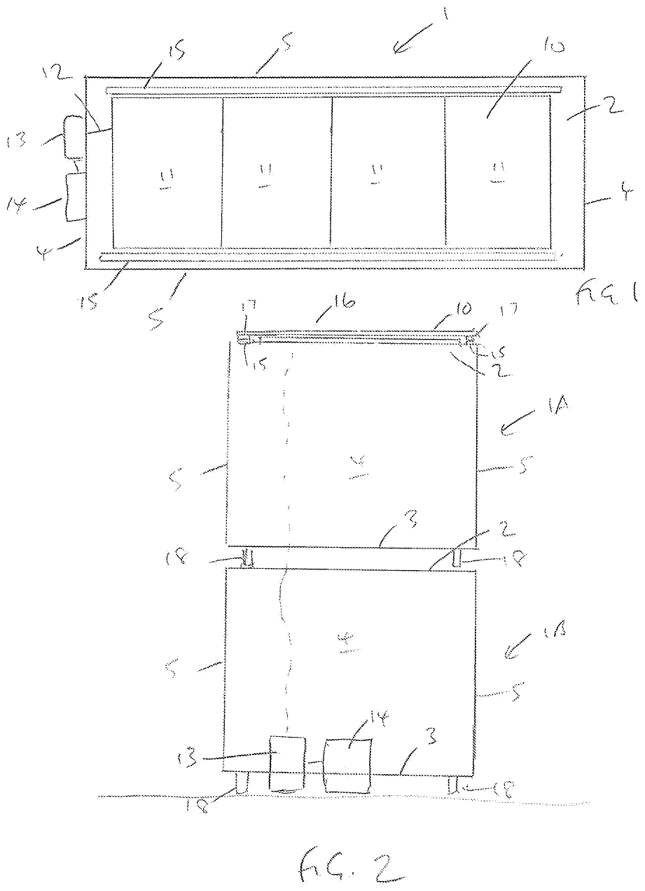

FIG. 1 is a schematic plan view of a cabin;

FIG. 2 is a schematic cross-sectional view of a pair of stacked cabins:

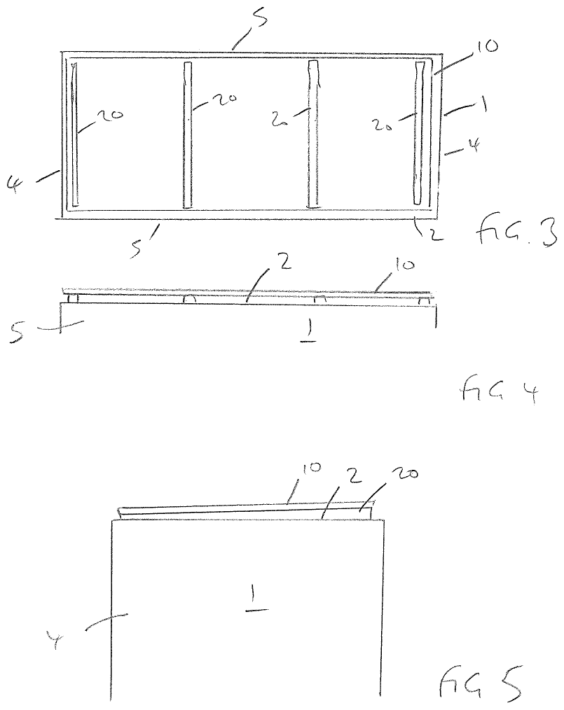

FIG. 3 is a schematic plan view of a second cabin;

FIG. 4 is a partial schematic side view of the second cabin; and

FIG. 5 is a partial schematic end view of the second cabin.

The portable cabin 1 shown in the figures is, in most senses, a conventional portable cabin which has a rectangular cuboid housing comprising a flat roof 2, a flat floor 3, end walls 4, and side walls 5.

A flat sheet of solar material 10 is attached to the roof 2.

The solar material may be a lightweight solar material such as glassless and frameless C—Si which is supplied as separate panels 11. Alternatively it may be a flexible solar material such as CIGS or OPV which can be unrolled as a single piece or as separate panels as shown.

As well as the solar material 10 itself having a low profile, the manner in which this is attached to the roof 2 also needs to be as thin as possible. For example, the material 10 may simply be glued to the roof. Alternatively it could be attached using Velcro® or by mechanical fasteners, such as screws.

The solar material 10 has an electrical connection 12 to a battery 13 which will reduce the load on a generator 14. These may be attached to, within or spaced from the cabin. Other electrical storage methods can be used.

The back up to the solar generation may be a diesel generator or mains power if available. Alternatively, it may be a hydrogen power source or wind power. The solar generation is cleaner than the first options and cheaper than the second options and is therefore beneficial either way.

Strips of Velcro® 15 extend along the edges of the solar material 10 adjacent to the rails 6. These allow for attachment of a protective layer 16 which is provided with complementary Velcro® strips 17 such that a protective layer 15 then protects the solar material 10. The protective material provides a degree of cushioning and is preferably a rubber mat or similar, such as the PROFIMAT® universal rubber mat.

The Velcro® may be positioned differently on the roof. For example, it may be intermittent and/or extend along end walls. As an alternative, other easy to detach mechanical fasteners such as poppers or eyelets may be used.

Prior to moving a cabin, all that is needed is for the optional protective layer 15 to be attached via the Velcro® strips 12, 16 or similar. The cabins can then simply be transported in a conventional manner.

When the cabins are used in the configuration shown in FIG. 2, cabin 1B is a conventional cabin, namely one which does not have solar material on the roof. Each cabin is supported on a pair of beams 18. The solar material 10 may be sized such that it will fit between the beams. Therefore, if the lower cabin is one which has solar material, this would not be damaged by being stacked in this way.

The cabins may be specially built in order to accommodate the solar material 10. Alternatively, the material can be applied to existing cabins as a retrofit.

Other modifications may be made to existing cabins. For example, if the cabin has a corrugated roof, a mounting layer may be laid across the corrugations in order to provide a mounting surface for the solar material. Alternatively, the solar material may be attached to the corrugated roof.

A second example is shown in FIGS. 3 to 5. This is the same in most respects as the first example.

The roof 10 of the cabin is provided with a number of batons 20 preferably made of plastic on which the solar material is attached. The batons may be adhered to the roof, or may embedded in the roof if the surface does not permit an adhesive to be used, for example, an asphalt roof. The solar material is then adhered top of the batons.

As shown in FIG. 5, the batons may have a slight incline to promote drainage from the roof, or they may be flat, particularly if the roof itself has a slight incline.

The arrangement for attaching the protective layer may need to be adapted to be slightly higher to compensate for the raised solar material.

1. A method of transporting portable cabins, at least one cabin comprising:
a flat roof and a flat floor connected by side walls, a layer of lightweight or flexible solar material attached flat to the flat roof,
the method comprising releasably attaching a protective layer to cover the solar material with the protective layer;
and transporting the cabin with the covered solar material in place.

2. A method according to claim 1, wherein the cabin further comprises stacking elements on the flat roof and/or on the flat floor; the stacking elements being complementary such that, when two cabins are stacked on one another, the stacking elements form a space for the solar material;
the method comprising stacking one cabin on top of another without removing the solar material and transporting the stacked cabins together.

3. A method according to claim 1, wherein the solar material has no glass layer.

4. A method according to claim 1, wherein the solar material is frameless.

5. A method according to claim 1, wherein the solar material is a crystalline silicon.

6. A method according to claim 1, wherein the mass of the solar material is less than 10 kg per square metre.

7. A method according to claim 1, wherein the total mass of the solar material and its mounting is less than 10 kg measured as the area of the solar material.

8. A method according to claim 1, wherein the solar material is adhered to the flat roof.

9. A method according to claim 1, wherein the cabin comprises a mechanical fastening mechanism attached to the roof at least partially surrounding the solar material, and the method comprises attaching the protective layer to the mechanical fastening mechanism.

10. A method according to claim 1, wherein the protective layer is a single sheet of a flexible material.

11. A method according to claim 1, wherein the protective layer is a cushioning layer.

12. A portable cabin comprising a flat roof and a flat floor connected by side walls, and
a layer of lightweight or flexible solar material attached flat to the flat roof.

13. A portable cabin according to claim 12, further comprising a mechanical fastening mechanism attached to the roof and at least partially surrounding the solar material.

14. A portable cabin according to claim 13, further comprising a protective layer releasably attached to the roof by the mechanical fastening mechanism and covering the solar material.

15. (canceled)

16. (canceled)

17. A portable cabin according to claim 12, wherein the solar material has no glass layer.

18. A portable cabin according to claim 12, wherein the solar material is frameless.

19. (canceled)

20. (canceled)

21. (canceled)

22. (canceled)

23. A portable cabin according to claim 12, further comprising stacking elements on the flat roof and/or the flat floor, the stacking elements being configured such that, when two cabins are stacked on one another, they provide a space between the cabins to accommodate the solar material.

24. A portable cabin according to claim 12, further comprising a gap between the layer of lightweight or flexible solar material and the roof.

25. A portable cabin according to claim 24, further comprising a plurality of batons attached to the roof, wherein the layer of lightweight or flexible solar material is adhered to the batons.

26. A portable cabin according to claim 12, wherein the top of the solar material is no more than 10 cm above the part of the flat roof to which the solar material is attached.

27. A portable cabin according to claim 12, wherein the solar material is inclined at an angle of less than 15 degrees with respect to the roof.
